(19) United States
(12) Patent Application Publication
(10) Pub. No.: US 2014/0182953 A1
(43) Pub. Date: Jul. 3, 2014

(54) ELECTRONIC SCALE

(71) Applicant: Fujikura Composite America, Inc., Vista, CA (US)

(72) Inventors: Alexander Tan DEE, Carlsbad, CA (US); Zhichen XI, San Diego, CA (US); Toni Marie Albano PIPES, Carlsbad, CA (US)

(73) Assignee: FUJIKURA COMPOSITE AMERICA, INC., Vista, CA (US)

(21) Appl. No.: 14/145,448

(22) Filed: Dec. 31, 2013

Related U.S. Application Data
(60) Provisional application No. 61/747,811, filed on Dec. 31, 2012.
(60) Provisional application No. 61/754,749, filed on Jan. 21, 2013.

(51) Int. Cl. G01G 23/37; G01G 19/00

(52) U.S. Cl. CPC G01G 23/3707; G01G 19/00
USPC 177/25.13

(57) ABSTRACT

A scale for measuring one or more golf club objects that may include a processor and a memory. The scale may also include first and second sensors in communication with the processor that are configured to generate respectively a first signal corresponding to a first load and a second signal corresponding to a second load, each load imparted from an object being measured. The scale may also include a set of computer instructions stored in the memory, wherein during operation the processor executes the instructions to calculate, based on the first and second signals, readings corresponding to a total weight, a center of gravity location, and a swing weight of the object being measured, the readings being output to a screen for substantially simultaneous display.

### CROSS-REFERENCE TO RELATED APPLICATIONS

This application claims the benefit under 35 U.S.C. §199(e) of provisional patent application Ser. No. 61/747,811, filed Dec. 31, 2012 and entitled ELECTRONIC SCALE and provisional patent application Ser. No. 61/754,749, filed Jan. 21, 2013 and entitled ELECTRONIC SCALE, each of which is hereby incorporated by reference.

### FIELD

The present disclosure is generally directed to scales for determining performance characteristics of a sporting instrument. More particularly, the present disclosure is directed to swing weight scales for determining the performance characteristics of a golf club, a golf club shaft, and/or components thereof.

### BACKGROUND

The following variables may be used for measuring and determining various performance characteristics of a golf club or club shaft: (1) Total club weight: may be expressed in grams; (2) Center of gravity location of the club: may be displayed as the distance in inches from the butt of the club; and (3) Swing weight: may be expressed using the Lorythmic scale (e.g., D-1.75), which some consider a golf industry standard for expressing swing weight. The swing weight may also be expressed in grams.

With respect to the swing weight scales currently available, these usually employ a “fulcrum” system that requires that the scale be properly balanced before using. One example of a known swing weight scale is the Golfsmith Professional Digital Swingweight Scale. Other known examples of swing weight scales can be found in U.S. Pat. Nos. 4,043,184, 4,058,312, 4,203,598, 5,285,680, 5,721,399, 5,814,773, 6,132,326, 6,765,156, 6,877,364, German Patent No. DE 3817485, United Kingdom Patent No. GB 2451172, and Japanese Patent No. JP 10076027, all of which are hereby incorporated by reference.

### BRIEF DESCRIPTION OF THE DRAWINGS

FIG. 1 shows a block diagram of an embodiment of a scale of the present disclosure.

FIG. 2 is another embodiment of a scale of the present disclosure.

FIG. 3 is a perspective view of an embodiment of a scale of the present disclosure.

FIG. 4 is a section view of the scale of FIG. 3.

FIG. 5 is perspective view of the inside of the scale, with a housing removed, of FIG. 3.

FIG. 6 is another embodiment of a scale without a housing according to the present disclosure.

FIG. 7 is another embodiment of a scale according to the present disclosure.

FIG. 8 illustrates an example of a computing system that may be used to employ embodiments described herein.

FIG. 9 is a block diagram of an exemplary electronic configuration of a scale according to the present disclosure.

FIG. 10 shows a method for calculating data according to the present disclosure.

FIGS. 11-13 show calculation parameters for calculating performance characteristics of a golf club/shaft according to the present disclosure.

FIG. 14 is a graph illustrating an example of a raw data reading of the swing weight of a golf club on a scale.

FIG. 15 is a graph illustrating a comparison of a swing weight reading of a golf club on a scale, with and without using a digital filter algorithm of the present disclosure.

FIG. 16 is a graph illustrating a comparison of a total weight reading of a golf club on a scale, with and without using a digital filter algorithm of the present disclosure.

FIG. 17 is a graph illustrating a comparison of a center of gravity location reading from a butt of a golf club on a scale, with and without using a digital filter algorithm of the present disclosure.

FIG. 18 is a block diagram of an illustrative weight change judgment algorithm.

FIG. 19 is a block diagram of an illustrative flicker removing algorithm.

### DETAILED DESCRIPTION OF THE PRESENT DISCLOSURE

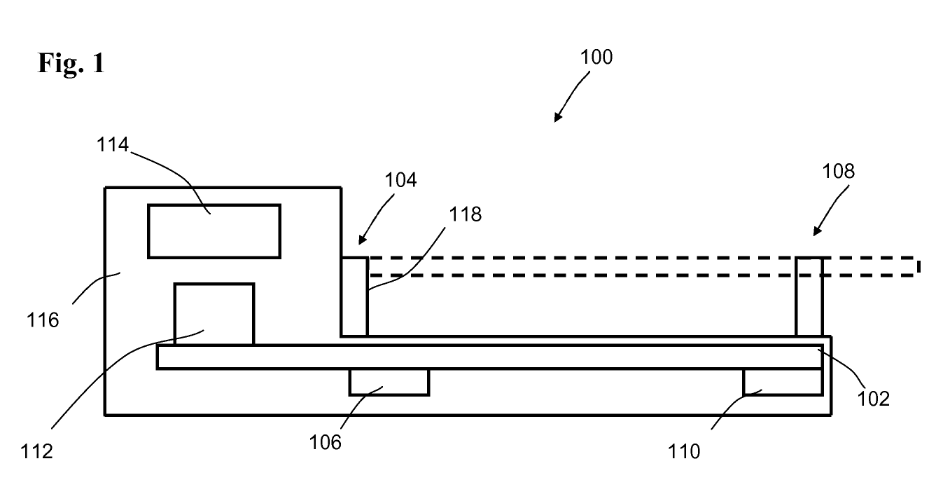

As shown in FIG. 1, a scale 100 may include a base 102, a first support 104 with a first sensor 106, a second support 108 with a second sensor 110, and a computing system 112 connected to sensors 106, 110 and to a screen 114. Scale 100 also may include a housing 116 and a positioner 118. Scale 100 may be configured such that either end of a golf club or golf club shaft can be held into position between first and second supports 104, 108. Scale 100 may also be configured to allow for the simultaneous measurement of various performance characteristics of a golf club. For example, the swing weight, center of gravity location, and club weight may be determined simultaneously by computing system 112 using readings from first and second sensors 106, 110, and displayed on screen 114. Scale 100 may be configured to measure various performance characteristics without the use of a fulcrum.

The length of second support 108 may be slightly longer than that of first support 104. An article, such as golf club or club shaft, may be positioned and supported between the first and second supports 104, 108. When so positioned and supported, a first force from the article (e.g., golf club) may be imparted upward against a first force point on first support 104, and a second force from the article (e.g., golf club) may be imparted downward against a second force point on second support 108.

First support 104 may include positioner 118 to ensure proper positioning of the article in scale 100. Positioner 118 may be a backstop, bar or any other stopper that provides a surface against which the article can abut when inserted into scale 300. For example, in FIG. 1, positioner 118 may take the form of a side wall of base 102 against which the golf club/shaft abuts when the golf club/shaft is inserted into scale 100. Positioner 118 may ensure that the golf club/shaft is properly positioned between first and second supports 104, 108 for example so that the sensors 106 and 110 are aligned or substantially aligned with the golf club/shaft respectively at the first and second force points.

First sensor 106 and second sensor 110 may be any sensor capable of measuring a force and/or load, and/or converting a force or load into a signal, such as an electrical signal. For example, first and second sensors 106, 110 may be a load cell, such as a mechanical or an electrical load cell. Types of load cells that could be used include a strain gauge or a hydraulic load cell. Other types of load cells that may be used include a bending beam cell, a parallel beam cell, a binocular beam cell, a canister cell, a shear beam cell, a single column cell, a multi-column cell, a pancake cell, a load button cell, a single ended shear beam cell, a double ended shear beam cell, an “S” type cell, an inline rod end cell, a digital electromotive force cell, a diaphragm/membrane cell, a torsion ring cell, a bending ring cell, a proving ring cell, a load pin cell, a resistive cell, a piezoelectric cell, a capacitance cell, an analog cell, a digital cell, and/or a wireless cell.

First sensor 106 can be the same or different as second sensor 110. One or more types of sensors can be used as first sensor 106 and/or as second sensor 110. One, two or more than two sensors can also be used as desired.

First sensor 106 may be positioned such that first sensor 106 is capable of measuring a first force imparted from the golf club. First sensor 106 may be positioned relative to first support 104 such that first sensor 106 is capable of measuring the first force imparted from the golf club. First sensor 106 may be positioned to take a reading of the first force point on first support 104 where the golf club imparts the first force.

Second sensor 110 may be positioned such that second sensor 110 is capable of measuring a second force imparted from the golf club. Second sensor 110 may be positioned relative to second support 108 such that second sensor 110 is capable of measuring the second force imparted from the golf club. Second sensor 110 may be positioned to take a reading of the second force point on second support 110 where the golf club imparts the second force.

First and second sensors 106, 110 may both be positioned below the golf club as shown in FIG. 1. Alternatively, first and second sensors 106, 110 may both be positioned above the club. One or more sensors may be disposed at any position desired that allows for measuring as desired one or more loads/forces imparted from one or more objects being analyzed using the scale.

The objects being analyzed may include a golf club, a golf club shaft, a golf club head, a golf club grip, a golf ball and/or any components thereof, together or individually. As can be appreciated, any object can be analyzed as desired using the scale.

The length or span between first and second sensors 106, 110 can vary as desired. In some embodiments, the length or span between the first and second sensors 106, 110 may be 10 inches.

Computing system 112 may be any type that is capable of processing data readings from first and second sensors 106, 110 to calculate performance characteristics of a golf club.

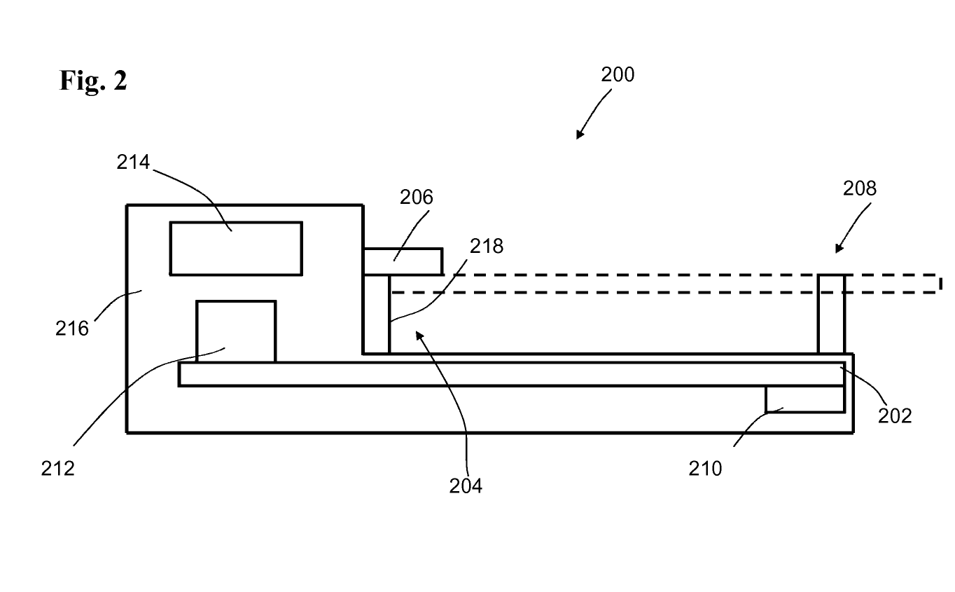

As shown in FIG. 2, a scale 200 may include a base 202, a first support 204 with a first sensor 206, a second support 208 with a second sensor 210, and a computing system 212 connected to sensors 206, 210 and to a screen 214. Scale 200 may also include a housing 216 and a positioner 218. In contrast to the scale of FIG. 1, first sensor 206 may be positioned above the club while second sensor 210 may be positioned below the club, or vice versa. If one sensor or more than two sensors are used, then the sensors may be placed in any array desired above, below, or around the article.

Placing one sensor above the club/shaft and the other below may allow for the scale to be smaller in size; and/or assure that any article (club, shaft, etc.) placed into the scale cannot fall off due to an imbalance of weight.

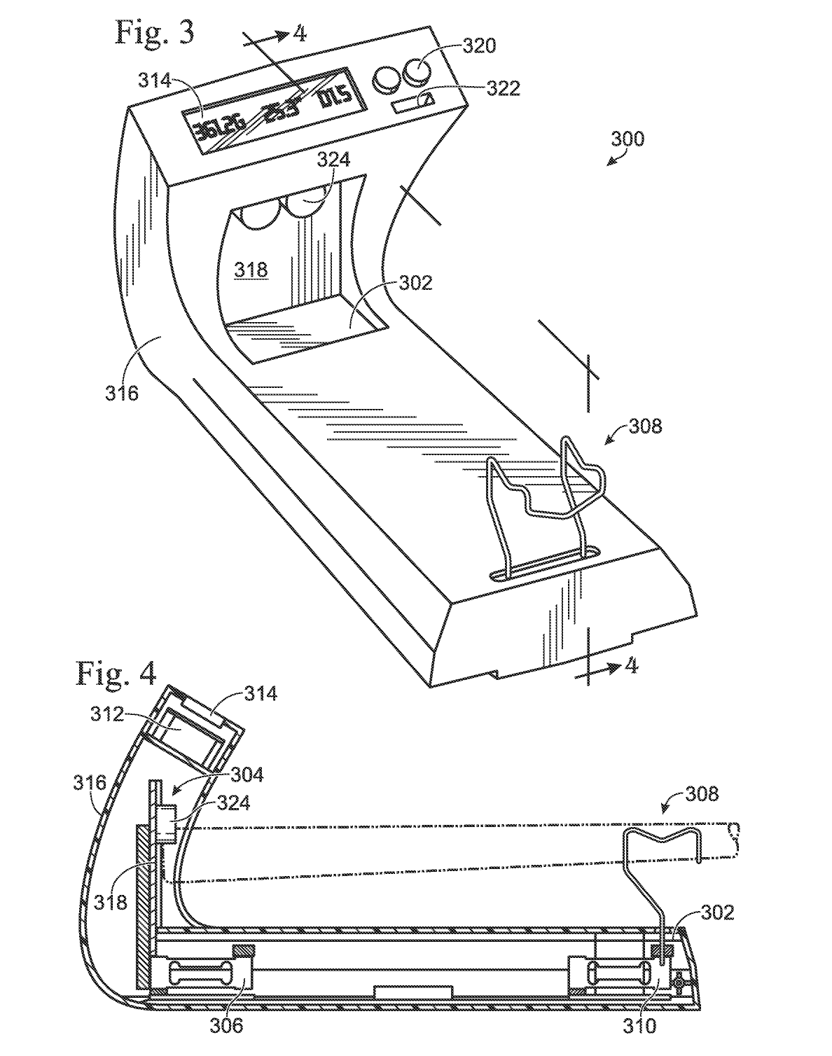

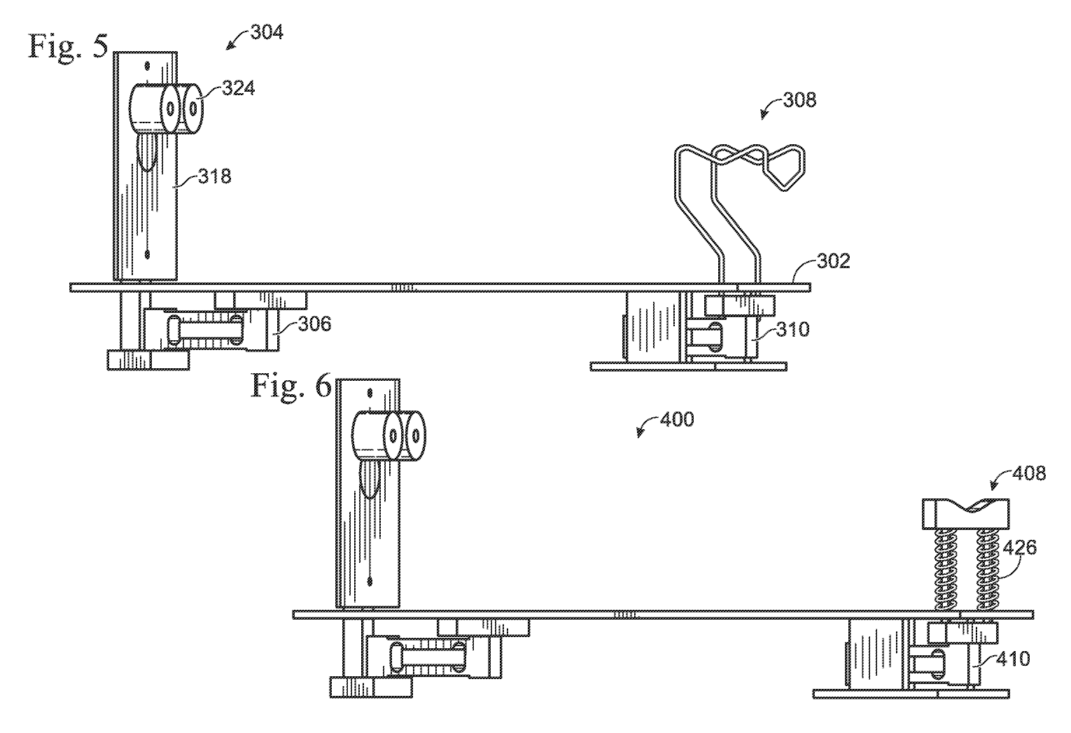

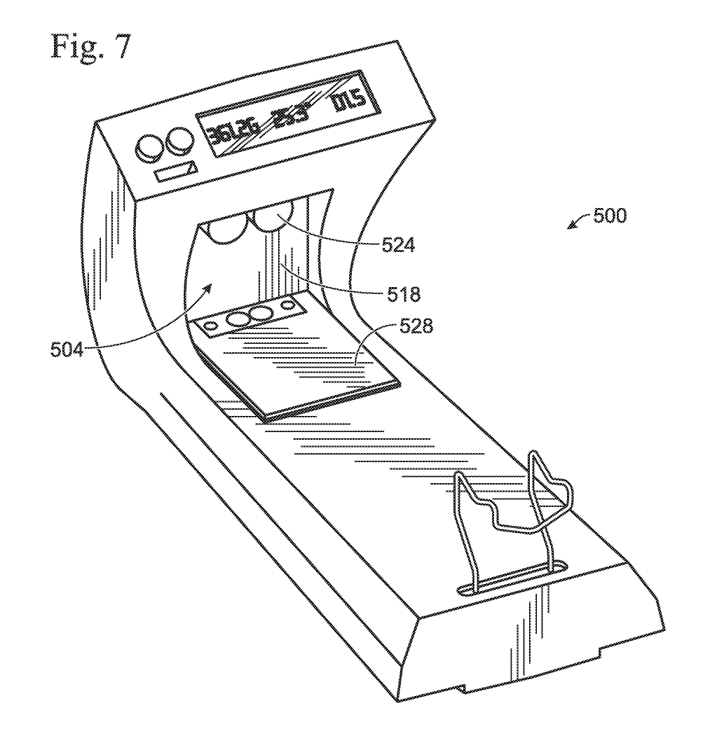

Turning to FIGS. 3, 4 and 5, another illustrative embodiment of a scale is generally indicated at 300. Scale 300 may include a base 302, a first support 304 with a first sensor 306, and a second support 308 with a second sensor 310. Scale 300 may also include a computing system 312 connected to sensors 306 and 310 and to a screen 314. Scale 300 may include a housing 316, a positioner 318, one or more buttons 320, a data port 322, and at least two rollers 324.

First support 304 may be any suitable structure configured to achieve the functionality described above regarding first supports, as well as to facilitate alignment of a club or shaft placed thereunder. For example, as shown in FIG. 3, first support 304 may include two rollers 324 mounted to positioner 318 in such a way that each roller is allowed to rotate about a respective axis. This arrangement may facilitate alignment of a shaft or other object by allowing the object to center itself between rollers 324. First sensor 306 may be mounted at a lower end of first support 304, as shown in FIG. 3. First sensor 306 may measure a first force imparted upward on first support 304 by way of rollers 324. For example, rollers 324 may be mounted to a side wall that is engaged with first sensor 306 such that when an upward force is applied to rollers 324, side wall may slide upward, creating an upward reading on first sensor 306. Rollers 324 may be engaged with first sensor 306 in any other way that may communicate the upward force applied to rollers 324, including a rod or other rigid member. First sensor 306 may also be configured to measure any force imparted in any direction by an article, including a force imparted upon first support 304. The arrangement of first sensor 306 at a lower end of first support 304 may place both sensors below base 302 and may improve durability and reduce wiring distances between the sensors and associated circuitry. The sensors may be located away from the support interfaces, thereby preventing damage and undesired mechanical jarring by keeping the sensors away from objects being placed onto or removed from the scale.

Second support 308 may be any suitable structure configured to carry out the functions described above regarding second supports. Second support 308 may also facilitate alignment and unassisted support of a club head or other object placed thereon. For example, as shown in FIG. 3, second support 308 may include a rigid or semi-rigid wire frame configured to function as a cradle or support for objects placed either lengthwise or crosswise on the support. For example, a grip or a club head may be placed on second support 308 and fully supported by second support 308 without the assistance of first support 304. At the same time, second support 308 is configured to maintain the capability of supporting a shaft or other object that is also supported by first support 304. First support 304 may be configured in a similar manner to second support 308. For example, both first and second supports 304, 308 may be configured to function as a cradle for objects placed on the support.

One or more dampers may be positioned between one or more sensors and the object being analyzed. For example, either first or second support (e.g. first or second support 106, 110; 206, 210; 306, 310), or both, may include a resilient member to serve as a damper. Due to the length and flexibility of a golf club, placing a club in a swing weight may cause the club to vibrate, creating unstable readings. First or second support (e.g. first or second support 106, 110; 206, 210; 306, 310) may include a resilient member to dampen the oscillations and more quickly create a stable reading. For example, rollers 324 of first support 304 may be rubber or any other material of a durometer suitable for dampening vibration. Second support 308 may include a semi-rigid wire frame configured to function as a cradle. The resiliency of the semi-rigid wire frame may dampen the vibrations of the golf club.

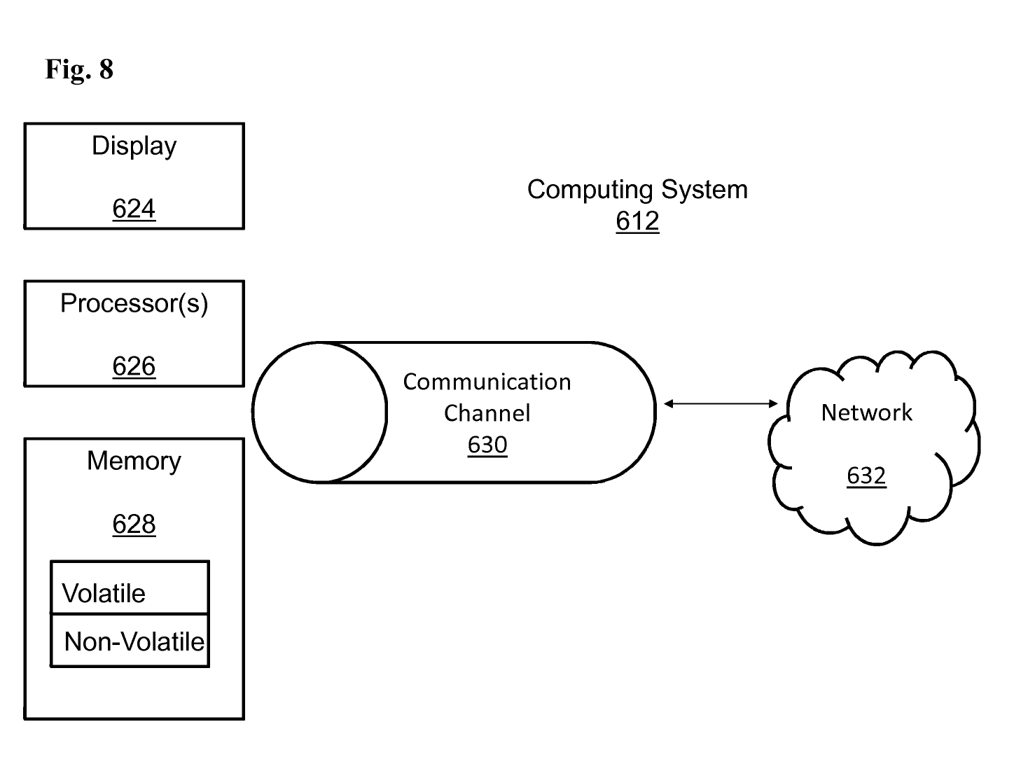

FIG. 6 shows an alternate embodiment of a scale according to the present disclosure. A scale 400 may include a second support 408. Second support 408 may include one or more springs 426 positioned between a golf club and second sensor 410. In one example, two springs connect a cradle or support for the article to the sensor. The two springs may include guideposts upon which the cradle or support may slide for stability. As described above, the resiliency of second support 408 may help to dampen the vibrations of a golf club to create a stable reading. A first support may also be configured similar to second support 408. For example, both a first support and second support 408 may include one or more springs as described above to dampen vibrations. Otherwise, the other components of the alternative embodiment of the scale shown in FIG. 6 may function as described herein for the other embodiments.

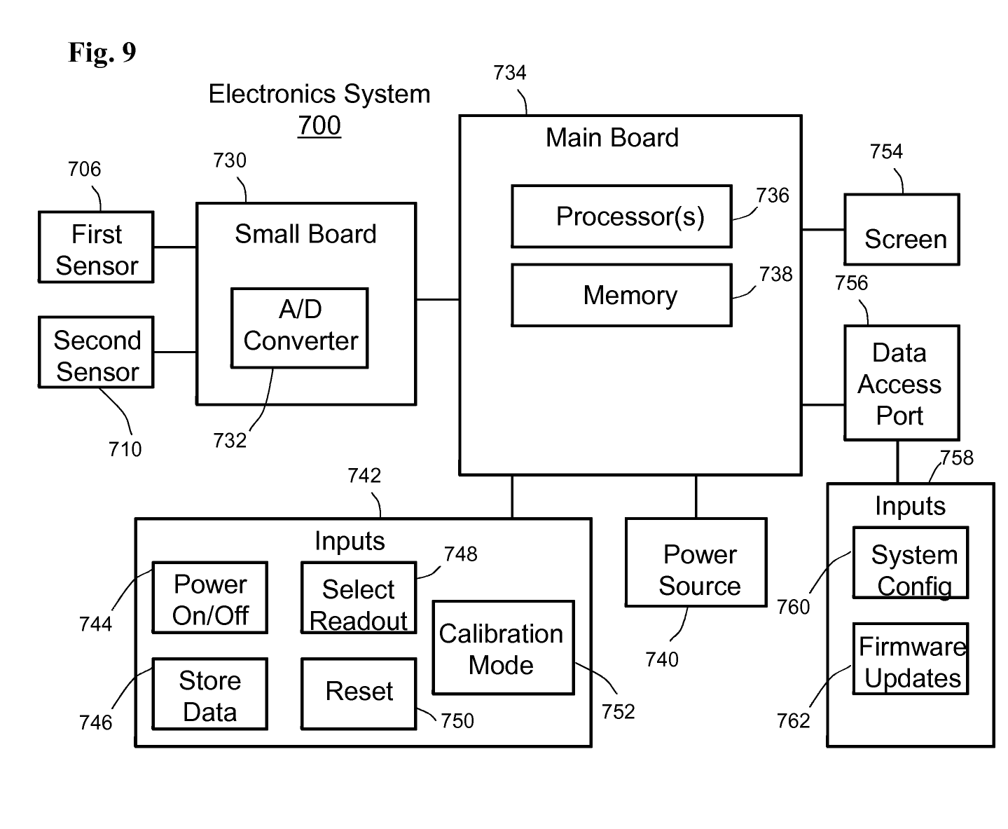

FIG. 7 shows another embodiment of a scale according to the present disclosure. A scale 500 may include a first support 504 including a positioner 518 and rollers 524. First support 504 may include a tray 528 attached to positioner 518 below rollers 524. The tray may be configured to weigh components of a golf club using a first sensor (not shown). Otherwise, the other components of the alternative embodiment of the scale shown in FIG. 7 may function as described herein for the other embodiments.

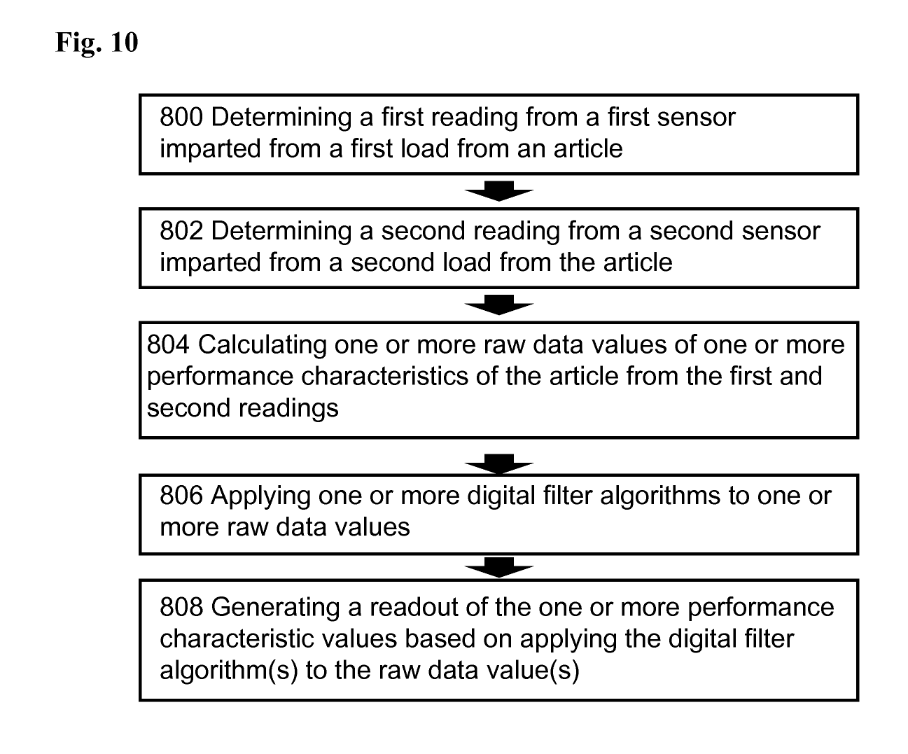

An introductory discussion regarding computing systems (e.g. computing systems 112, 212, and/or 312) is described with respect to FIG. 8. Computing systems are now increasingly taking a wide variety of forms. Computing systems may, for example, be handheld devices, appliances, laptop computers, desktop computers, mainframes, distributed computing systems, or even devices that have not conventionally been considered a computing system. In this disclosure, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 8, in its most basic configuration, a computing system 612 typically includes at least one processing unit 626 and memory 628. The memory 628 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the present disclosure, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 628 of the computing system 612.

The computing system 612 also may include screen or display 624 that may be used to provide various concrete user interfaces, such as those described herein. Screen or display 624 may be any type of display screen. For example, screen 624 may be a LCD screen. The LCD screen may be a screen capable of displaying simultaneously the performance characteristics being measured, such as club weight, swing weight, and center of gravity location.

Computing system 612 may also contain communication channels 630 that allow the computing system 612 to communicate with other message processors over, for example, network 632. Communication channels 630 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include a computer program product having computer-readable media for carrying or having computer-executable instructions or data structures stored thereon. Such computer-readable media (or machine-readable media) can be any available media that can be accessed by a general purpose or special purpose computer. By way of example, and not limitation, such computer-readable media can comprise physical non-transitory storage and/or memory media such as RAM, ROM, EEPROM, CD-ROM, DVD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the present disclosure is not necessarily limited to the specific features or acts described herein. Rather, the specific features and acts described herein are disclosed as examples. The computer-executable instructions cause the computer or processing device to perform the function or group of functions because the computer-executable instructions have a certain structure. If digitally represented, for example, such structures may represent one or more bits of information. In the case of magnetic storage media, for example, such a structure may be a level and/or orientation of magnetism on the media at predetermined parts of the magnetic storage media. In the case of optical storage media, for example, such a structure may be a level of reflectivity of the media at particular predetermined parts of the optical media.

Computing system 612 may be configured in the present disclosure to measure any performance characteristic desired, including any that can be determined from one or both of first and second sensors (e.g. first and second sensors 106, 110; 206, 210; 306, 310). For example, computing system 612 may be configured to measure the swing weight, center of gravity location, and total club weight of a golf club from the first and second sensors (e.g. first and second sensors 106, 110; 206, 210; 306, 310). Computing system 612 may be configured to apply algorithms to calculate the swing weight, center of gravity location, and club weight based on the data received from the first and second sensors (e.g. first and second sensors 106, 110; 206, 210; 306, 310). From this load response, all data may be calculated without a fulcrum. From this load response, all data may be calculated simultaneously and displayed on screen (e.g. screen 114, 214, 314).

Computing system 612 may be in communication with the first and second sensors (e.g. first and second sensors 106, 110; 206, 210; 306, 310). and/or the screen (e.g., screen 114, 214, 314) in several ways, such as wirelessly or via a wired connection. Computing system 612 may be coupled to the scale (e.g. scale 100, 200; 300), such as by being housed within a housing (e.g., 116, 216, 316), such as shown in the embodiments of FIGS. 1-3. Computing system 612 may also be positioned outside of the scale (e.g., scale 100, 200, 300).

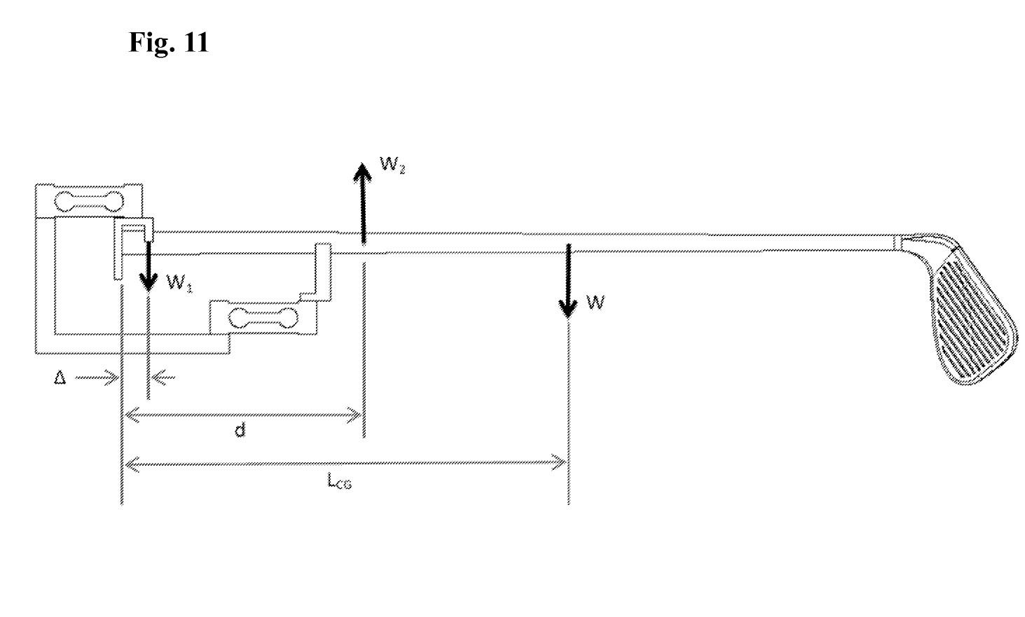

FIG. 9 is a block diagram showing an example of an electronics system of a scale according to the present disclosure. Electronics system 700 may include a first sensor 706 (that may correspond to sensor 106, 206, 306) and a second sensor 710 (that may correspond to sensor 110, 210, 310). As discussed above, first and second sensors 706, 710 may be load cells. Electronics system 700 may include a small board 730 that may include one or more circuits configured to receive data from first and second sensors 706, 710. Small board 730 may include one or more analog-to-digital converter 732. Electronics system 700 may also include a main board 734 that may be a Printed Circuit Board (PCB) configured to calculate total weight, center of gravity, and swing weight based on the received data.

As shown in FIG. 9, first and second sensors 706, 710 may be connected to a single small board 730. Alternatively, electronic system 700 may include a small board for each sensor. Analog-to-digital converter 732 may convert analog data from the load cell into digital data, which then may be sent to the main board 734. This arrangement may facilitate noise reduction in load circuits. Additionally, the output of a load cell may be proportional to an excitation voltage, and any drift in the excitation voltage may result in a change in the output of the load cell. To resolve this issue, small board 730 may be configured to utilize a ratiometric measurement approach. In a ratiometric circuit, the excitation voltage of a load cell is also the reference voltage of an analog-to-digital converter (ADC). As the excitation voltage changes, the outputs of the load cell and ADC change as well in order to maintain the ratio. Consequently, a change in excitation voltage does not cause any error in measurement. Small board 730 may be connected to an associated load cell through a short cable that may be approximately 50 mm long.

Main board 734 may include one or more processors 736 for carrying out calculations and other functions of a scale of the present disclosure. Main board 734 may also include memory 738. A power source 740 may be connected to main board 740 to provide power. Inputs 742 may be connected to main board and configured to supply user-selected commands to main board 734. Inputs 742 may include a power on/power off input 744, a store data input 746, a select readout input 748, a reset input 750, and a calibration mode input 752. Power on/power off input 744 may initiate or terminate the supply of power to main board 734. Store data input 746 may instruct processors 736 to store data calculated by main board 734 in memory 738 or in another storage medium. Select readout input 748 may send instructions to the main board to output one or more of a selection of results from calculations. Reset input 750 may reset the data and calculations of main board 734. Calibration mode 752 may be used to calibrate a scale of the present disclosure, including by zeroing readouts from sensors, calibrating readouts from sensors, or any other calibration method utilized by a scale of the present disclosure.

Main board 734 may output data to a screen 754 by way of a circuit on main board 734, which may be an LCD circuit configured to display output data on an LCD screen. Main board 734 may include a data access port 756 which may be a USB port or any other port suitable for accessing data from and/or sending data to main board 734. Data access port 756 may allow the output of data to an external storage medium. Data access port 756 may also be connected to data access inputs 758, which may include system configuration input 760 and firmware update input 762. Through system configuration input 760, main board 734 may be connected to an external computing device that may then set the configurations of the system. Firmware update input 762 may include an external computing device that may upload and install firmware updates to main board 734. Firmware update input 762 may also include any other storage medium storing a firmware update that may be uploaded to main board 734.

In some embodiments, the components of small board 730 and main board 734 may be combined into one board.

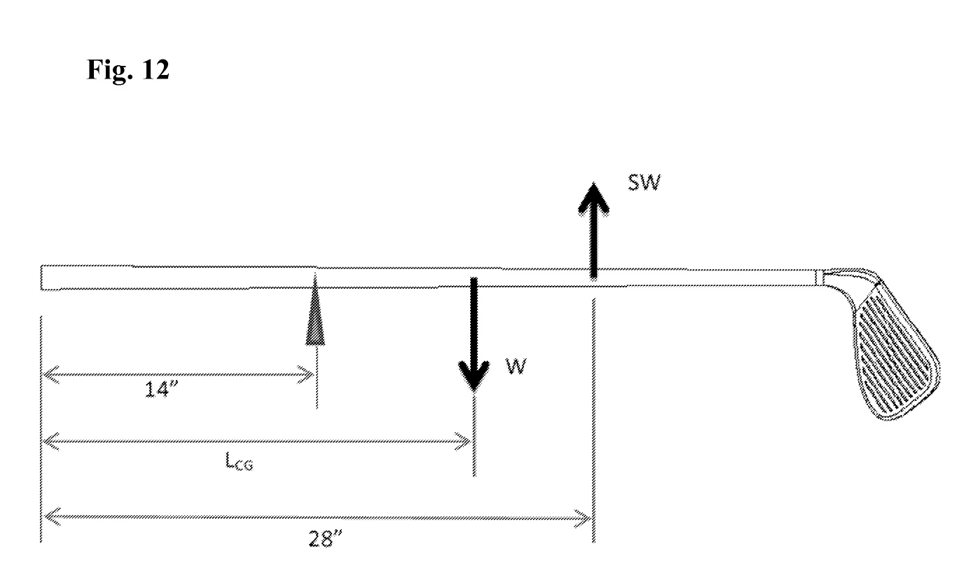

FIG. 10 refers to a method of calculating performance characteristic values for an article using a scale of the present disclosure. Starting with 800, a first reading may be determined that is imparted from a first load from an article on the scale. For example, the computing system (e.g. computing system 112, 212, 312) may obtain a reading based on the first force of the golf club or shaft on the scale from the first sensor (e.g. first sensor 106, 206, 306, 706).

In 802, a second reading may be determined that is imparted from a second load from the article on the scale. For example, the computing system (e.g. computing system 112, 212, 312) may obtain a reading based on the second force of the golf club or shaft on the scale from the second sensor (e.g. second sensor 110, 210, 310, 710). It will be appreciated that 800 and 802 may occur simultaneously or substantially simultaneously, and that 800 may occur before 802, or vice versa.

In 804, one or more raw data values may be calculated of one or more performance characteristics of the article from the first and second readings. For example, the computing system (e.g. computing system 112, 212, 312) may be configured to calculate raw data values of the swing weight, total weight, and center of gravity location for a golf club based on the readings from the first and second sensors (e.g. first and second sensors 106, 110; 206, 210; 306, 310; 706,710).

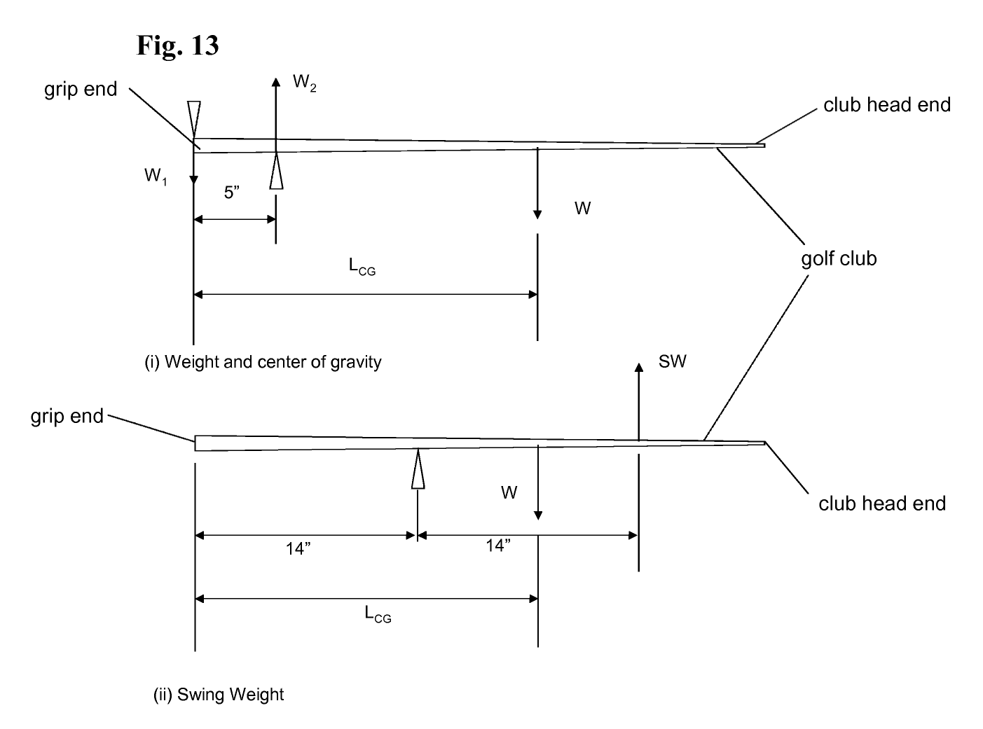

For example, FIGS. 11-13 illustrate algorithms of the computing system (e.g. computing system 112, 212, 312) for calculating the swing weight, total weight and center of gravity location. Shown is a representation of a club with the grip end to the left and the club head end to the right. When the club is placed into the scale (e.g. scale 100, 200, 300), the first sensor (e.g. first sensor 106, 206, 306, 706) may measure the force or load, W₁ at the first force point on the club, and the second sensor (e.g. second sensor 110, 210, 310, 710) may measure the force or load, W₂ at the second force point on the club. From the readings of the load or force taken by the first and second sensors (e.g. first and second sensors 106, 110; 206, 210; 306, 310; 706,710) at the first and second force points, various performance characteristics of the club can be determined. In FIGS. 11-13, W, L_{CG}, and SW denote the weight, center of gravity location, and swing weight of the club, respectively.

Referring to FIG. 11, the weight, W and center of gravity location, L_{CG} of the club may be calculated as follows:

$$W = {W}_{2} - {W}_{1}$$

$$and$$

$${L}_{CG} = \frac{{W}_{2} d - {W}_{1} Δ}{W}$$

Δ and d may be the distances of the first and second force points from the positioner (e.g. positioner 118, 218, 318, 518), respectively. Δ and d may the distances from any reference point desired (e.g., a reference point on the club, scale, etc.).

Referring to FIG. 12, the swing weight, SW of a golf club may be calculated as follows:

$$SW = \frac{( {L}_{CG} - 14 ) W}{14}$$

The 14 in the calculation may be the distance, in inches, from the positioner (e.g. positioner 118, 218, 318, 518). The 14 inches and 28 inches in FIG. 9b may be the distance from the positioner (e.g. positioner 118, 218, 318, 518). The 14, 14 inches, and 28 inches may be the distances from any reference point desired (e.g., a reference point on the club, scale, etc.).

FIG. 13 may depict another embodiment showing how to calculate the W, L_{CG}, and SW, for a golf club/shaft with scales and calculations of the present disclosure.

It will be appreciated that these calculations may be used for calculating total weight, swing weight, and the center of gravity location for any embodiment of a scale of the present disclosure.

It will be appreciated that the computing system (e.g. computing system 112, 212, 312) can calculate the raw data for swing weight, total weight and center of gravity location simultaneously, substantially simultaneously, or in any order desired.

Turning back to FIG. 10, in 806 one or more digital filter algorithms may be applied to one or more raw data values of the one or more performance characteristics. As discussed above, unstable readings have been an issue faced in the development of a golf club scale. The length of a golf club is typically much greater than that of a scale. Consequently, when a golf club is placed on a scale, it overhangs. The flexible shaft and heavier club head may cause the club to vibrate vertically immediately after placement in the scale. Because air damping is small, the vibration lasts a while before it comes to rest. During the oscillation of the club, a scale may display unstable readings when only the raw data values are displayed.

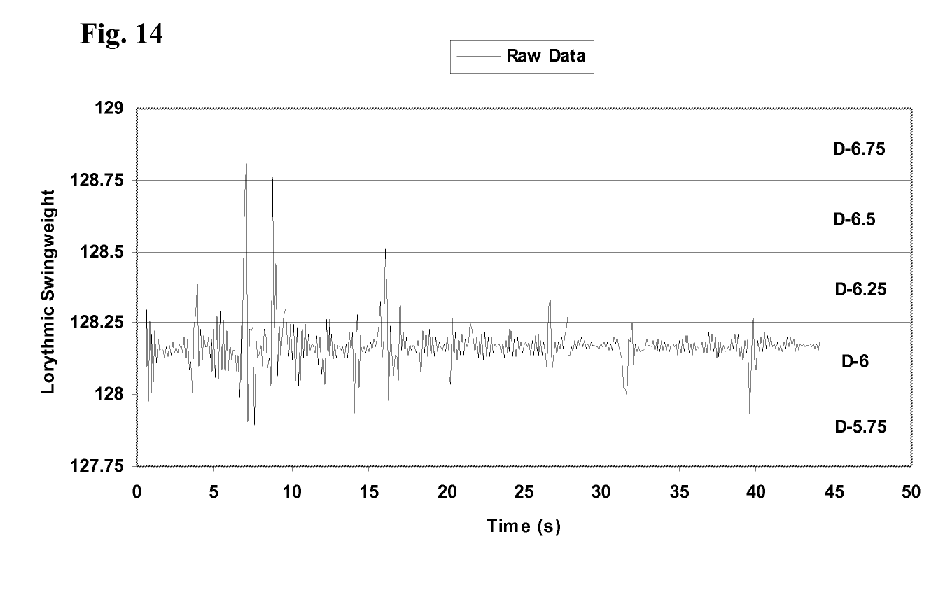

For example, FIG. 14 shows an example of a raw data reading for the Lorythmic swing weight on a scale for a golf club. In this example, the graph shows that the swing weight raw data value readings of the golf club can change between ˜D-5.75 and ˜D-6.75 for approximately 40 seconds before the reading in this example stabilized at ˜D-6. That would mean that it would take ˜40 seconds before being able to obtain an accurate data reading.

The present disclosure may apply a digital filter algorithm as part of the software of the scale. The digital filter algorithm procedure may apply to the data as follows:
a) Take N raw data on the scale: Data 1, Data 2, . . . , and Data N.
b) Remove maximum and minimum values in the array, and average remaining values. Output the mean value as the first swing weight reading.
c) Take another N raw data: Data 2, Data3, . . . , and Data (N+1). Repeat the step b) to obtain the second swing weight reading.
d) Repeat steps above for more raw data until the swing weight readings stabilize.

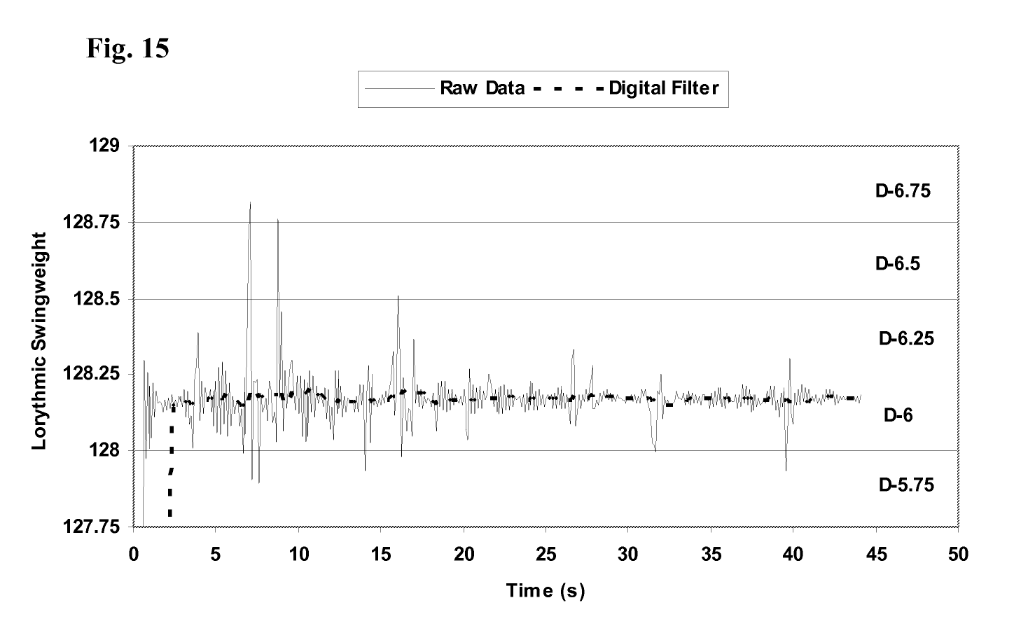

To verify the accuracy of the digital filter algorithm, FIG. 15 shows the algorithm applied to the raw data values of FIG. 14. In this example, 20 raw data value readings are taken at a time. FIG. 15 illustrates a comparison of the swing weight readings of the golf club with (called Digital Filter) and without (called Raw Data) using the present digital filter algorithm. The results in this example indicate that with the digital filter algorithm it may take approximately 2.3 seconds for the scale to output an accurate and stable swing weight reading (in this example, ˜D-6).

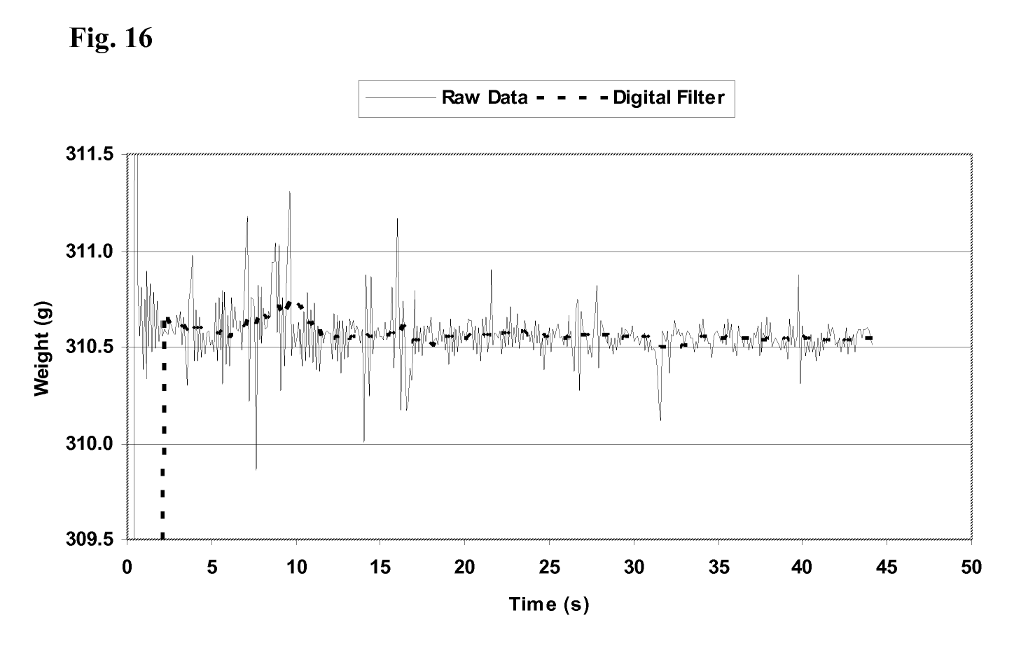

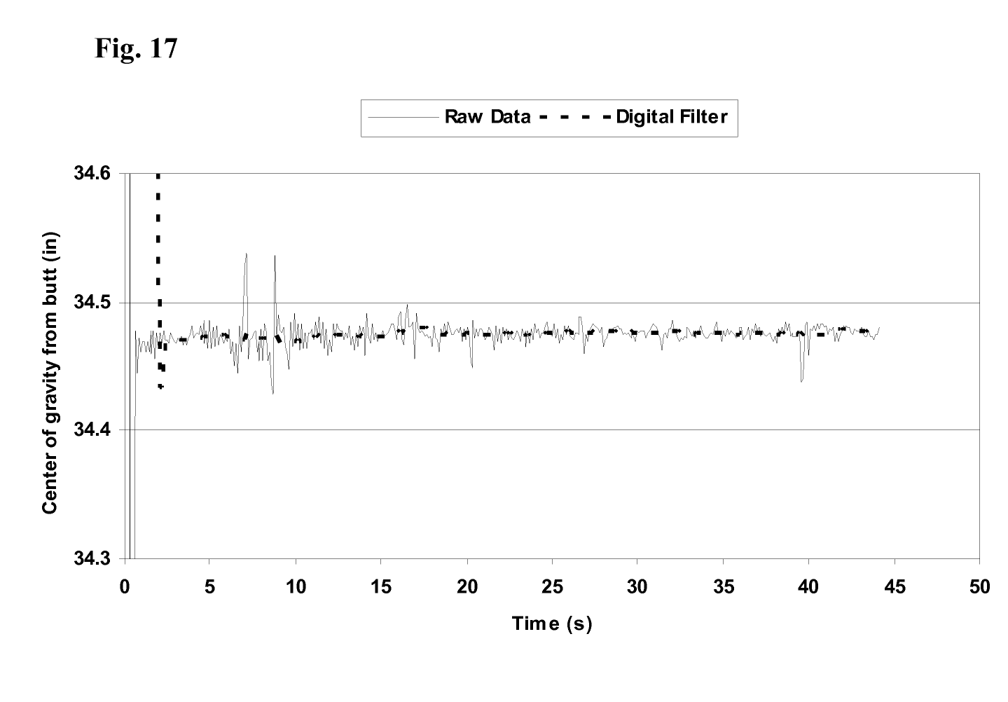

The digital filter algorithm also can be applied to the raw data for the total weight and center of gravity location readings of a golf club. Examples comparing the weight and center of gravity location readings of the golf club with (Digital Filter) and without (Raw Data) using the present digital filter algorithm are presented in FIGS. 16 and 17, respectively. From these examples, it can be seen that the present digital filter algorithm may allow a scale to output stable weight and center of gravity location readings accurately and fast as well.

In some embodiments, the frequency of taking N raw data points in a) above may be taking ten samples per second. It will be appreciated that more or less than ten samples per second can be taken, as desired. It will also be appreciated that any number of samples in any interval can be taken, as desired.

In some embodiments, the N raw data points in a) above may comprise Data 1 through Data 10. For c) above, the N raw data points may be Data 11 through Data 20, or it may be Data 2 through Data 11, as desired.

In some embodiments, in b) above, the highest maximum value and the lowest minimum value may be removed. In some embodiments, the highest maximum value may not be removed and/or the lowest minimum value may not be removed. In some embodiments, more than one of the highest maximum values and/or more than one of the lowest maximum values may be removed. The remaining values may be analyzed or averaged in any way desired, e.g., by determining the mean, medium, mode, etc. of the remaining values.

In some embodiments, the condition for determining that a filtered result is stable in d) above may be determining if subsequent readings fall within a readability or tolerance range of the scale for the performance characteristic being measured. The readability or tolerance ranges for the scale of the present disclosure for measuring performance characteristics of golf clubs or shafts may be as follows: total weight may be +/−0.5 grams; the center of gravity location may be +/−0.05 inches; and the swing weight may be +/−0.25 points. It will be appreciated that the tolerance or readability ranges can be altered as desired, for example based on user preference or on the tolerance or readability range for a scale.

The digital filter algorithm of the present disclosure as described above may be used in conjunction with a first and/or second support that includes a resilient member for vibration dampening in order to generate a stable output reading as quickly as possible.

Returning to FIG. 10, 808 may be generating a readout of performance characteristic values based on applying the digital filter algorithm to the raw data value. Readouts generated by computing system (e.g. computing system 112, 212, and/or 312) may be displayed on screen (e.g. screen 114, 214, and/or 314). An example of a readout is shown in FIG. 3. Scale (e.g. scale 100, 200, and/or 300) may be configured to display a readout of continuous raw data values, continuous data values after applying the digital filter algorithm, and/or after the data value readings stabilize, as desired.

Several possible advantages may be derived from the scale of the present disclosure. Possible advantages include (a) a scale that is capable of measuring swing weight, total weight and center of gravity location of golf clubs and shafts; (b) a scale capable of measuring all of those measurements at once; (c) a scale that has no moving parts (all digital, not mechanical) and is compact; (d) no fulcrum required for measurements; (e) a scale that outputs stable and accurate (e.g., measurements are accurate within a required tolerance, such as half a swing weight point) readings; (f) a scale that is easier and faster to use than existing systems since there is no balance weight to adjust to obtain swing weight; and (g) a scale that is smaller than existing systems because the sensors can be positioned at any points together because all calculations are done mathematically without reliance on reading a fulcrum (e.g., in some embodiments, the total length of the device may be 12 inches, which is a smaller footprint than current scales).

In some embodiments, it is possible to increase or decrease the distance between the first and second sensor (e.g. first and second sensors 106, 110; 206, 210; 306, 310). The algorithms of the program can be adjusted accordingly to account for such a different selected length. In some embodiments, the grip head end of the golf club could be inserted into the scale, and in other embodiments the club head end of the golf club could be inserted into the scale. In some embodiments, the scale may be configured so that either end of the article can be inserted into the scale. The algorithms of the program could be adjusted accordingly to calculate and measure whatever performance characteristics are desired, including swing weight, total weight, and the center of gravity location. So long as the program has some reference to the butt end of the club, the program may solve for the swing weight and center of gravity location.

In some embodiments, the screen of a scale of the present disclosure may include an LCD display capable of simultaneously displaying total weight, center of gravity, and/or swing weight. In some examples, the swing weight may be displayed in a font or character size approximately twice as large as other information on the screen.

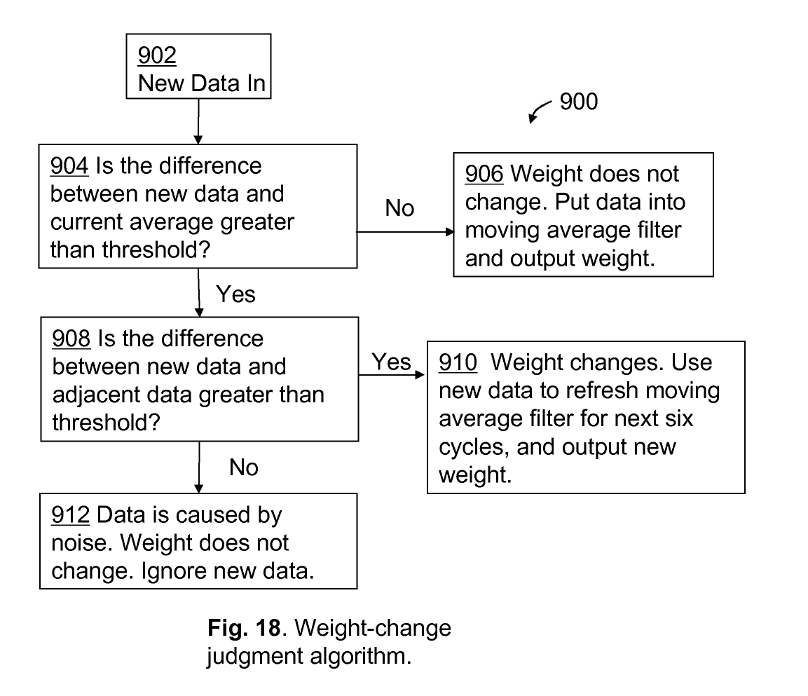

Scale (e.g. scale 100, 200, and/or 300) may include software similar to that described above. The scale software may include a Weight Change Judgment Algorithm such as algorithm 900 shown in FIG. 18 to control the response of the scale to a change in weight data. After a weight change, the output of the load cell should move to another balanced state in a very short time. The output of the filter can only indicate the most correct result after the filter refreshes a certain number of times. The response time may be limited by the number of averaging points. Step 902 may include receiving weight data. Step 904 may include checking whether a difference between the new data and a current average data value is greater than, or greater than or equal to, a predetermined threshold. The threshold may be factory-set or may be adjustable by the user. Step 906 may include maintaining the current displayed weight and placing the data into a moving average filter if the threshold of step 904 is not exceeded. If the threshold of step 904 is exceeded, then step 908 may include checking whether the new data exceeds adjacent data by another factory-set or user-adjustable threshold. If the threshold of step 908 is exceeded, the displayed weight is changed to the new value, and the new data may be used in step 910 to refresh the moving average filter for a certain number of cycles, for example six cycles. If the threshold of step 908 is not exceeded, step 912 may include determining that the new data is caused by noise, the previously displayed weight may be maintained, and the new data may be ignored.

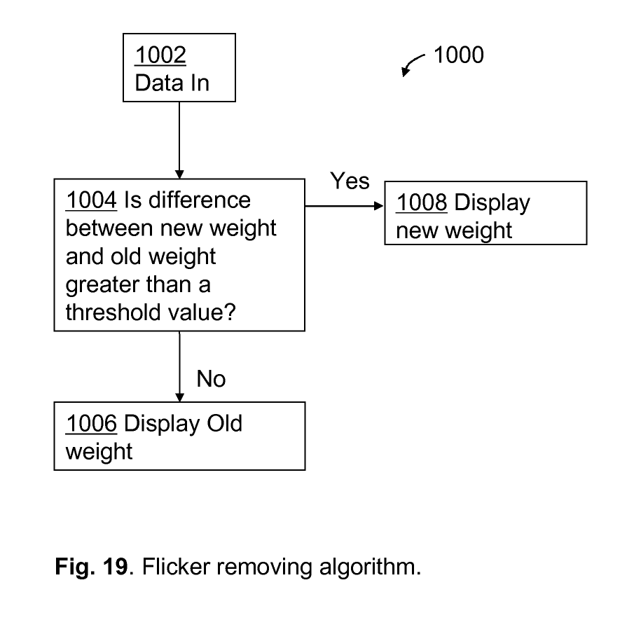

The scale software may include a Flicker Removing Algorithm such as algorithm 1000 shown in FIG. 19 to control the response of the scale to flickering or alternating between two displayable weight values. The balance may be aligned to display in 0.1-gram divisions or increments. When the actual weight is in the margin between two adjacent display weights, the display may flicker between the two weights. To keep the display stable, an algorithm such as algorithm 1000 may be applied. Step 1002 may include receiving weight data. Step 1004 may include checking whether the absolute difference between the new weight and old weight exceeds a certain threshold. If the difference between the new weight and the old weight does not exceed the threshold in step 1004, then the previously displayed weight may be maintained in step 1006. If the new weight and old weight are different by more than the threshold of step 1004, then the new weight may be displayed in step 1008.

From the above description and accompanying drawings, it should be understood that the following functionalities may be enabled by a scale, in addition to those previously discussed. First, the weight of a golf grip may be measured. For example, a grip may be placed in the second (lower) support, and the weight of the grip may be measured and displayed by the scale. Second, the weight of a golf club head may be measured. For example, a club head may be placed on the second (lower)_support, and the weight of the head may be measured and displayed by the scale. Third, the weight of so-called “dry” components may be measured together to estimate swing weight, center of gravity location, and total weight of an assembled club. In this context, dry may mean unglued components placed together or located in close proximity in order to simulate an assembled product. For example, a grip may be first attached to a shaft using adhesive tape. Because the grip end has a certain thickness, the shaft may need to be located such that it would account for the grip end thickness. The adhesive tape may need to be positioned one-half of its length away from the shaft end. Then the shaft may be installed into a club head. The resulting club may be placed on the scale, and its swing weight, CG location, and total weight may be displayed on the LCD screen.

Additionally, one or more of the described embodiments of a scale may be used to measure weight and other characteristics of various objects in various fields of endeavor. For example, measuring the total weight, center of gravity location, and swing weight characteristics of various objects, and individual components of objects, may be useful in various fields of endeavor. For example, the scale may be used in the field of archery to measure arrows, arrow heads, and/or bows. In another example, the scale may be used in the field of tennis and racket sports to measure items such as rackets, ping pong rackets, badminton rackets, cricket sticks, polo sticks, and lacrosse sticks. In the field of track and field sports, the scale may be used to measure items such as javelins and/or vaulting poles. In other examples, the scale may be used in the field of baseball to measure bats, in the field of hockey to measure hockey sticks, in the field of angling to measure fishing poles, in the field of hand-held weapons to measure objects such as spears, tomahawks, and knives, and in the field of hand tools to measure objects such as ax handles and ax heads. In the field of musical instruments, the scale may be used to measure items such as violin bows, drumsticks, and xylophone mallets. In the field of firearms, the scale may be used to measure items such as rifles and handguns, and/or parts thereof such as stocks, grips, and barrels.

One or more embodiments of the present disclosure may include one or more of the following concepts:
A digital scale having one or more load cells wherein the load cells are capable of producing the requisite data to measure swing weight, center of gravity location, and total weight simultaneously.
A digital scale capable of allowing for either the butt end or the head end of the club to be positioned underneath the top load cell, wherein the club can be placed in either direction on the scale for determining total weight, swing weight, and center of gravity location.
A scale that does not employ a fulcrum for measuring swing weight, total weight and/or center of gravity location.
A scale that is calibrated to measure all of swing weight, total weight, and the center of gravity location for a golf club/shaft.
A scale that has no moving parts, does not require any balancing to take a reading, and is designed to perform all measurements electronically.
A scale that has one load cell positioned above the club and the other below the club.
A scale that is capable of allowing for either the butt end of the club or the club head end of the club to be positioned underneath the top load cell. In other words, a scale where either end of the club can be inserted into the scale for performing all necessary calculations.
A scale that is capable of facilitating centering of the shaft of a club using an upper support having side-by-side rollers.
A scale having a lower support capable of independently supporting a measured object.
A scale having a PCB capable of receiving and analyzing data inputs from two load cells simultaneously.
A scale having one or more resilient members capable of dampening the oscillation of the object being measured (i.e., club shaft, club, etc.) and stabilizing readings more quickly.
A scale having a tray capable of individually measuring components such as the club head and/or grip.

One or more embodiments of the present disclosure may include one or more of the following concepts in the following Paragraphs:
Paragraph A. A scale for measuring one or more golf club objects, comprising: a processor; a first sensor in communication with the processor, the first sensor configured to generate a first signal corresponding to a first load imparted from an object being measured; a second sensor in communication with the processor, the second sensor configured to generate a second signal corresponding to a second load imparted from the object being measured; a memory in communication with the processor; and a set of computer instructions stored in the memory, wherein during operation the processor executes the instructions to calculate, based on the first and second signals, readings corresponding to a total weight, a center of gravity location, and a swing weight of the object being measured, the readings being output to a screen for substantially simultaneous display.
B. The scale of Paragraph A, wherein the object being measured includes a golf club shaft positioned on the scale for measurement.
C. The scale of Paragraph A, wherein the first sensor measures the first load corresponding to a first force imparted by the object being measured and the second sensor measures the second load corresponding to a second force imparted by the object being measured.
D. The scale of Paragraph A, further comprising a damper disposed between the second sensor and the object being measured.
E. The scale of Paragraph D, wherein the damper is a resilient member capable of dampening vibrations generated by the object being measured.
F. The scale of Paragraph E, wherein the resilient member is formed into a cradle capable of holding all or a portion of the object being measured.
G. The scale of Paragraph D, wherein the damper includes a coiled spring.
H. The scale of Paragraph A, wherein the processor further executes the instructions to determine a first reading from the first signal of the first sensor and a second reading from the second signal of the second sensor, and to calculate, based on the first and second readings, raw data value readings of the total weight, the center of gravity location, and the swing weight of the object being measured.
I. The scale of Paragraph H, wherein the processor further executes the instructions to apply a digital filter algorithm to the raw data value readings, the digital filter algorithm functioning to generate a stabilized digital output reading for the total weight, the center of gravity location, and the swing weight of the object being measured that is output for display on the screen.
J. The scale of Paragraph I, further comprising a first damper disposed between the first sensor and the object being measured and a second damper disposed between the second sensor and the object being measured.
K. The scale of Paragraph J, wherein the first damper includes a positioner comprised of rubber.
L. The scale of Paragraph K, wherein the second damper includes a resilient member capable of dampening vibrations generated by the object being measured, the resilient member being formed into a cradle capable of holding all or a portion of the object being measured.
M. The scale of Paragraph A, further comprising an analog-to-digital converter disposed between the processor and the first and second sensors, wherein the first and second signals are converted respectively to first and second digital signals by the analog-to-digital converter for analysis by the processor.
N. The scale of Paragraph A, further comprising a positioner to position the object being measured on the scale.
O. The scale of Paragraph N, wherein the positioner includes a pair of wheels disposed on a wall, the wheels and the wall configured to position the object being measured on the scale.
P. The scale of Paragraph O, wherein the pair of wheels are in communication with the first sensor.
Q. The scale of Paragraph P, wherein the processor, the memory, and the first and second sensors are housed within a housing of the scale.
R. The scale of Paragraph N, wherein the object being measured imparts a first force upon the positioner that is the first load, and the first sensor is in communication with the positioner to measure the first load to generate the first signal.
S. The scale of Paragraph A, further comprising a tray connected to the first sensor, the tray being configured to accept an object to measure.
T. The scale of Paragraph A, further comprising: a positioner having a body positioned vertically relative to the ground and a bottom end coupled to the first sensor, a pair of wheels being coupled to the body such that the body and the pair of wheels are configured to position a first end of the object being measured on the scale; and a cradle disposed at a distal position from the positioner, the cradle being in communication with the second sensor and configured to position a portion of the object being measured on the scale, wherein the object being measured imparts a first upward force on the positioner that is the first load and a second downward force on the cradle that is the second load.

The disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

What is claimed is:

1. A scale for measuring one or more golf club objects, comprising:
a processor;
a first sensor in communication with the processor, the first sensor configured to generate a first signal corresponding to a first load imparted from an object being measured;
a second sensor in communication with the processor, the second sensor configured to generate a second signal corresponding to a second load imparted from the object being measured;
a memory in communication with the processor; and
a set of computer instructions stored in the memory, wherein during operation the processor executes the instructions to calculate, based on the first and second signals, readings corresponding to a total weight, a center of gravity location, and a swing weight of the object being measured, the readings being output to a screen for substantially simultaneous display.

2. The scale of claim 1, wherein the object being measured includes a golf club shaft positioned on the scale for measurement.

3. The scale of claim 1, wherein the first sensor measures the first load corresponding to a first force imparted by the object being measured and the second sensor measures the second load corresponding to a second force imparted by the object being measured.

4. The scale of claim 1, further comprising a damper disposed between the second sensor and the object being measured.

5. The scale of claim 4, wherein the damper is a resilient member capable of dampening vibrations generated by the object being measured.

6. The scale of claim 5, wherein the resilient member is formed into a cradle capable of holding all or a portion of the object being measured.

7. The scale of claim 4, wherein the damper includes a coiled spring.

8. The scale of claim 1, wherein the processor further executes the instructions to determine a first reading from the first signal of the first sensor and a second reading from the second signal of the second sensor, and to calculate, based on the first and second readings, raw data value readings of the total weight, the center of gravity location, and the swing weight of the object being measured.

9. The scale of claim 8, wherein the processor further executes the instructions to apply a digital filter algorithm to the raw data value readings, the digital filter algorithm functioning to generate a stabilized digital output reading for the total weight, the center of gravity location, and the swing weight of the object being measured that is output for display on the screen.

10. The scale of claim 9, further comprising a first damper disposed between the first sensor and the object being measured and a second damper disposed between the second sensor and the object being measured.

11. The scale of claim 10, wherein the first damper includes a positioner comprised of rubber.

12. The scale of claim 11, wherein the second damper includes a resilient member capable of dampening vibrations generated by the object being measured, the resilient member being formed into a cradle capable of holding all or a portion of the object being measured.

13. The scale of claim 1, further comprising an analog-to-digital converter disposed between the processor and the first and second sensors, wherein the first and second signals are converted respectively to first and second digital signals by the analog-to-digital converter for analysis by the processor.

14. The scale of claim 1, further comprising a positioner to position the object being measured on the scale.

15. The scale of claim 14, wherein the positioner includes a pair of wheels disposed on a wall, the wheels and the wall configured to position the object being measured on the scale.

16. The scale of claim 15, wherein the pair of wheels are in communication with the first sensor.

17. The scale of claim 16, wherein the processor, the memory, and the first and second sensors are housed within a housing of the scale.

18. The scale of claim 14, wherein the object being measured imparts a first force upon the positioner that is the first load, and the first sensor is in communication with the positioner to measure the first load to generate the first signal.

19. The scale of claim 1, further comprising a tray connected to the first sensor, the tray being configured to accept an object to measure.

20. The scale of claim 1, further comprising:
a positioner having a body positioned vertically relative to the ground and a bottom end coupled to the first sensor, a pair of wheels being coupled to the body such that the body and the pair of wheels are configured to position a first end of the object being measured on the scale; and
a cradle disposed at a distal position from the positioner, the cradle being in communication with the second sensor and configured to position a portion of the object being measured on the scale,
wherein the object being measured imparts a first upward force on the positioner that is the first load and a second downward force on the cradle that is the second load.
